(19) United States
(12) Patent Application Publication
(10) Pub. No.: US 2003/0159721 A1
(43) Pub. Date: Aug. 28, 2003

(54) Food serving preparation oven with a cleaning device

(75) Inventor: Christoph Stephan, Raesfeld (DE)

Correspondence Address: ROBERT W. BECKER & ASSOCIATES, Suite B, 707 Highway 66 East, Tijeras, NM, 87059, US

(73) Assignee: Ubert Gastrotechnik GmbH, Raesfeld (DE)

(21) Appl. No.: 10/370,956

(22) Filed: Feb. 20, 2003

(30) Foreign Application Priority Data
Feb. 22, 2002 (DE) 10207604.9

(51) Int. Cl. B08B 3/04

(52) U.S. Cl. 134/108; 134/169 R; 134/198; 134/104.4

(57) ABSTRACT

A food serving preparation oven is provided and includes a plurality of walls forming a heating area in which food servings to be heated are disposed and a cleaning fluid circulation assembly for performing selected cleaning of the heating area. The cleaning fluid circulation assembly is operable to circulate cleaning fluid through a loop which includes the heating area, a sump area, and a pressure side area. The cleaning fluid circulation assembly includes a pump to effect movement of cleaning fluid to an in-loop outlet opening, which opens into the heating area. A fluid distribution element disposed within the heating area at a spacing from the in-loop outlet opening directs a portion of cleaning fluid in a first directed stream into the heating area and directs another portion of cleaning fluid in a second directed stream into the heating area.

### BACKGROUND OF THE INVENTION

The present invention relates to a food serving preparation oven having a cleaning device.

Some food serving preparation ovens, such as steam combination ovens and hot air ovens for the preparation of foodstuffs, are provided with automatic cleaning devices which comprise a circulation loop in which water having a cleaning medium added thereinto is circulated. The water is set in circulation by a pump and is distributed via nozzles into the interior of the oven, so that the debris and dirt therein is loosened by the chemical action of the cleaning fluid and the mechanical action of the injected water. After the conclusion of the cleaning cycle, the fluid having the debris entrained therewith is pumped out and a clean rinsing is undertaken. The assembly is thereafter again ready for further food serving heating operations.

The known cleaning systems which are based upon a water circulation process can be classified into two categories - namely, on the one hand, those systems with a movable spray head or spray arm by which a rotating nozzle support having spray arms is set into rotation by the water pressure and, on the other hand, those systems with fixedly mounted spray nozzles which, in the manner of high pressure cleaners, comprise a plurality of spray nozzles having water flowing therethrough under high pressure.

In connection with those systems having a movable spray head, it is necessary to dispose the spray head in the cooking space. This installation location is problematic in that the location of the spray head in the cooking space results in the spray head, during the normal operation of the device, being impacted by fat, steam, food stuff particles, and heat. For this reason, it is provided in connection with many devices that the movable spray head is to be removed during the normal operation from the cooking space and is to be installed in the cooking space in connection with the commencement of a cleaning program. A special cleaning of the installation mounting is, however, required in many circumstances.

In connection with the second category of known cleaning system variants—namely, those having fixedly mounted spray nozzles these spray nozzles are provided with relatively small free cross-sections and have fluid flowing therethrough under high pressure so that the cleaning solution exits such spray nozzles at a high velocity and the need for a corresponding mechanical cleaning implementation is thereby avoided. These spray nozzles have, on the one hand, relatively expensive production costs and, on the other hand, these spray nozzles have a relatively high loading of the circulating cleaning fluid having debris solids remnants therein, as do the first variation of cleaning systems described above. These debris remnants must be filtered out of the circulation loop as the pumps and the spray nozzles with their small free cross-sections deployed in connection with such systems are especially sensitive to blockage. The requisite large filter surfaces are not maintenance-friendly and typically lead to problems.

### SUMMARY OF THE INVENTION

The present invention provides a solution to the challenge of providing a cleaning system for food serving preparation devices, such as ovens for foodstuffs, which makes possible a circulation of a water-based cleaning fluid by simple means and which ensures a reduced manual intervention and maintenance effort in connection with its operation.

By virtue of the fluid circulation loop comprising at least one in-loop outlet opening in the cooking space for the passage therethrough of the cleaning fluid and a fluid distribution element, preferably, a baffle device, disposed at a spacing from the in-loop outlet opening, the debris which eventually accumulates on the baffle device during food serving preparation operations can be reliably carried away via the cleaning fluid at the beginning of the cleaning cycle without blocking the cleaning device. In this connection, it is advantageous if the in-loop outlet opening has a cross section of at least 100 mm². Moreover, it is preferable if a pump is provided which ensures a feed volume of at least 100 liters per minute. The pressure differential created by the pump is, during operation, preferably under 1 bar and, especially, is under 0.5 bar.

In one advantageous embodiment of the present invention, the in-loop outlet opening, along with the baffle device spaced therefrom, is disposed on the top side or ceiling of the cooking space and, especially, is disposed generally centrally on the top side or ceiling. The baffle device can, in this connection, be pot-shaped, whereby a completely peripherally-extending gap between the adjacent wall of the cooking space and the rim of the baffle device oriented toward the wall of the cooking space is provided. Furthermore, the baffle device can be disposed generally rotationally symmetrically to the middle axis of the in-loop outlet opening and can comprise nozzle slots which open both in the direction of the middle axis as well as radially to the middle axis. Moreover, a nozzle opening can be provided in the base of the baffle device at the middle axis or immediately adjacent thereto, the nozzle opening being oriented toward those components of the cooking space which extend centrally of the heating area.

An embodiment of the present invention is described hereinafter in connection with the figures of the drawings.

### BRIEF DESCRIPTION OF THE DRAWINGS

FIG. 1 is a front elevational schematic view, in section, of one embodiment of the cleaning device of the present invention in an exemplary configuration thereof as a hot air oven; and

FIG. 2 is an enlarged perspective view of the baffle device shown in the hot air oven shown in FIG. 1.

### DETAILED DESCRIPTION OF THE PREFERRED EMBODIMENT

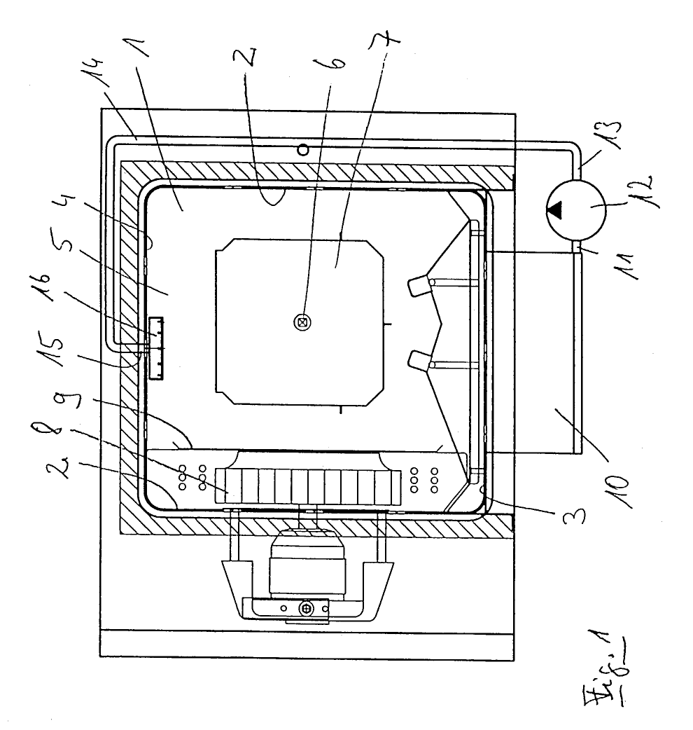

FIG. 1 shows an oven in accordance with the present invention, the oven being shown in a schematic sectional view. The oven comprises a heating space or chamber 1 formed by a pair of side walls 2, a floor wall 3, a top wall or ceiling 4, and a back wall 5. The oven is configured in the manner of a hot air oven with a basket 7 mounted for rotation about an axis 6 in the heating space 1. A hot air stream is directed by a hot air blower 8 onto the basket 7. The air stream is, in this connection, guided through a guide shield 9.

A sump 10 is disposed underneath the heating space 1 and is operable to collect the cleaning fluid with debris entrained therewith. The cleaning fluid, as is conventional, is a solution of water with a portion thereof comprised of a cleaning medium.

The sump 10 is communicated with a circulation pump 12 via a suction side 11. The circulation pump 12 effects, during a cleaning cycle, movement of the fluid to a pressure side 13 and, beyond that, along a riser conduit 14 to an in-loop outlet opening 15 which extends through the top wall 4 generally centrally thereof and opens into the heating space 1.

A baffle device 16 is located underneath the in-loop outlet or discharge opening 15 at a spacing therefrom, the baffle device being contacted by the cleaning fluid circulated around the circulation loop by the pump 12 during a cleaning cycle and effecting a distribution of the cleaning fluid into the heating space 1 and, especially, along the walls 2, 3, 4, and 5.

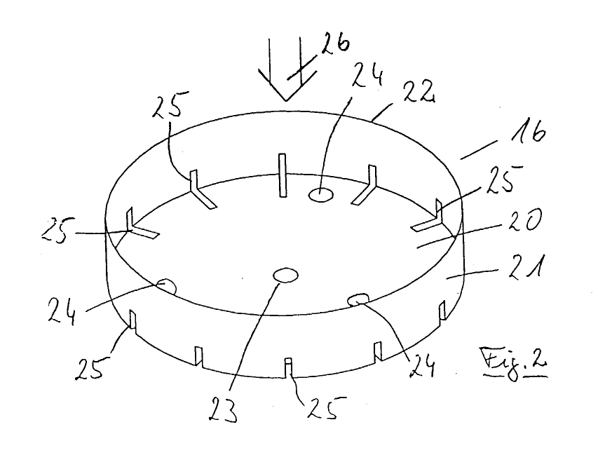

FIG. 2 shows an enlarged perspective view of the baffle device 16 of the oven illustrated in FIG. 1.

The baffle device 16 is formed as a single piece of stainless steel in a substantially pot-shaped configuration. The baffle device includes a base area 20, which is circular. A cylindrically shaped sleeve edge region 21 extends from the edge of the base region 20, and its upper free end has a planar, annular rim or edge 22.

The base region 20 is provided, in total, with four throughbores, one of which, a middle throughbore 23, serves, during a cleaning cycle operation, as a nozzle opening while the outer throughbores 24 serve in connection with the mounting of the baffle device 16 under the top wall 4 of the oven, as seen in FIG. 1. In this connection, in the area of the throughbores 24, the baffle device 16 is threadably connected to three mounting bolts whose length is selected such that a ring-shaped gap of approximately 1-1.5 mm in height is formed between the edge 22 and the top wall 4. Additionally, the baffle device 16 comprises a plurality of nozzle slots 25. The nozzle slots 25 are cut into the corner formed by the base region 20 and the edge region 21 and extend through the base region 20 to the same extent as they extend through the edge region 21. The nozzle slots have a width of approximately 1-1.5 mm and the length of the pair of shanks of each nozzle slot, which are oriented at right angles to one another, is around 6 millimeters.

During a cleaning cycle operation for cleaning of the heating space 1 of the oven shown in FIG. 1, a predetermined amount of cleaning medium is added into the sump 10. Thereafter, a corresponding amount of water is introduced into the sump 10 in a controlled manner by a not-illustrated control. The circulation pump 12 is set into operation to draw water by suction through the suction side 11 out of the sump 10 and to effect movement, via pressure increase, of the water along the riser conduit 14 to the in-loop outlet opening 15. As the cleaning fluid exits the in-loop outlet opening in the general direction shown by an arrow 26 in FIG. 2, the cleaning fluid bounces off of the baffle device 16. The baffle device 16 distributes the cleaning fluid such that a first portion thereof flows through the annular gap formed between the edge 22 and the top wall 4 and wets the entirety of the top wall 4. This first portion of cleaning fluid thereafter runs along the side walls downwardly and, in particular, in fact, runs behind the guide shield plate 9. The cleaning fluid which has run down the side walls 2, the back wall 5, and the not-illustrated front wall, flows again into the sump 10. A second portion of the cleaning fluid is expelled in the manner of a shower spray through the nozzle slots 25 which, by reason of their geometry, effect a type of “sprinkling” of the heating space 1. The cleaning fluid exits out of the nozzle slots 25 as a finely distributed spray stream. A third portion of the cleaning fluid exits via the throughbore 23 and fans out underneath the baffle device 16. The basket 7 of the embodiment shown in FIG. 1 is wetted via this cleaning fluid exiting the throughbore 23, the basket preferably being rotated during the cleaning cycle.

The cross sections of the suction side 11 and the pressure side 13 of the pump 12, as well as the cross section of the riser conduit 14, the cross section of the in-loop outlet opening 15, and the various nozzle openings, are dimensioned such that, in the illustrated oven embodiment, a high volume of cleaning fluid of 200-250 liters per minute can be flowed therethrough. A diameter of 15-20 mm has shown itself to be particularly suitable. A low pressure differential of approximately 0.4 bar is necessary for this high volume stream by reason of the relatively large cross sections of the nozzle openings and the conduits. Due to the low pressure differential and the high volume stream, an entrainment of a portion of the debris particles in the circulating cleaning fluid can be tolerated so that the cleaning fluid flowing out of the heating space 1 into the sump 10 can, in each instance, be pre-filtered by a wide-mesh sieve. A sieve of this type can be a small surface sieve as the cumulative amount of the particles retained thereby remains relatively small.

Upon the completion of the actual cleaning cycle involving circulation of the cleaning fluid, the cleaning fluid is pumped out of the sump 10 by a not-illustrated pump and is replaced by pure water which, as the occasion arises, can have a clarification agent added thereto. A second circulation with this replacement water floats the remainder of the debris particles and the remainder of the cleaning fluid out of the heating space 1. After a repeat pumping out of the clarification water, the cleaning process is at an end and the oven is again ready for its food serving preparation operation.

In contrast to the known cleaning devices for food serving preparation ovens, the inventive device has an especially reduced maintenance requirement as neither high pressure nozzles with small free cross-sections nor movable nozzles or spray arms need be deployed. The cross sections of the cleaning systems, are so large that the debris scarcely impacts the circulation of the cleaning fluid. Any encrustation in the region of the baffle device 16 which occurs during the food serving preparation operation has already been reliably flushed away at the beginning of the cleaning process so that there is only a very low risk that a nozzle slot 25, the throughbore 23, or the annular gap above the edge 22 is blocked. The large cross sections and, in particular, the wide-meshed filter in the region of the sump 10, are particularly insensitive to the particle debris arising from the operation of the oven. In those cleaning devices, which operate with high pressure and small volume streams, the filtering in the region of the sump 10 must be configured in a considerably more complex manner and, especially, must be configured with a relatively larger surface, so that the particle loading on the sieve is not blocked during the cleaning process.

With the inventive cleaning device, a hot air oven operable to prepare French fries which itself is subjected to a strong encrustation can nonetheless be cleaned with a cleaning time of approximately 90 minutes, whereby the water usage for each cleaning cycle amounts to only 25 liters. The amount of the required cleaning medium can, in contrast to known cleaning devices, be cut approximately in half. The illustrated embodiment is well suited for heating spaces having approximately parallelepipedal base surfaces. Additionally, particularly in connection with heating spaces having longitudinal right-angled base surfaces, a plurality of in-loop outlet openings 15 and baffle devices 16 are provided.

The specification incorporates by reference the disclosure of German priority document 102 07 604.9 filed Feb. 22, 2002.

The present invention is, of course, in no way restricted to the specific disclosure of the specification and drawings, but also encompasses any modifications within the scope of the appended claims.

What is claimed is:

1. A food serving preparation oven, comprising:
a plurality of walls forming a heating area in which food servings to be heated are disposed; and
a cleaning fluid circulation assembly for performing selected cleaning of the heating area, the cleaning fluid circulation assembly being operable to circulate cleaning fluid through a loop which includes the heating area, a sump area into which flows cleaning fluid having debris from the heating area entrained therewith, and a pressure side area, and the cleaning fluid circulation assembly including a device for applying a motive force to the cleaning fluid to effect movement of cleaning fluid, from which debris has been disentrained, from the sump area to the pressure side area of the loop and, thereafter, to an in-loop outlet opening which opens into the heating area, and a fluid distribution element disposed within the heating area at a location relative to the in-loop outlet opening for receiving cleaning fluid exiting the in-loop outlet opening such that the fluid distribution element directs a portion of cleaning fluid in a first directed stream into the heating area and directs another portion of cleaning fluid in a second directed stream into the heating area .

2. A food serving preparation oven according to claim 1 wherein the in-loop outlet opening has a free cross sectional area of at least 100 mm².

3. A food serving preparation oven according to claim 1, wherein the motive force device applies a motive force to the cleaning fluid such that the rate of flow of the cleaning fluid is at least 100 liters/minute.

4. A food serving preparation oven according to claim 1, wherein the motive force device produces a pressure differential during circulation of cleaning fluid in a cleaning cycle operation, of less than 1 bar and, especially, less than 0.5 bar.

5. A food serving preparation oven according to claim 1, wherein one of the plurality of walls forming the heating area forms the ceiling of the heating area and the in-loop outlet opening is formed in this ceiling-forming wall and, especially, is formed generally centrally in this ceiling-forming wall.

6. A food serving preparation oven according to claim 4, wherein the fluid distribution element is configured in a pot shape with a pot base and a peripheral pot side extending from the pot base and having a pot rim at its free end, the fluid distribution element being mounted at a spacing from the ceiling-forming wall such that a gap is formed between the pot rim and the ceiling-forming wall through which the first directed stream of cleaning fluid flows.

7. A food serving preparation oven according to claim 1, wherein cleaning fluid exits the in-loop outlet opening along an exit axis and the fluid distribution element is disposed generally symmetrically to the exit axis.

8. A food serving preparation oven according to claim 1, wherein cleaning fluid exits the in-loop outlet opening along an exit axis and the fluid distribution element includes a base and a peripheral side wall extending from the base in encircling relationship to the exit axis and a plurality of distribution slots each having a portion extending axially along the peripheral side wall and another portion extending radially along the base.

9. A food serving preparation oven according to claim 1, wherein cleaning fluid exits the in-loop outlet opening along an exit axis and the fluid distribution element includes a base and a peripheral side wall extending from the base in encircling relationship to the exit axis and a nozzle opening through which a portion of cleaning fluid distributed by the fluid distribution element exits into the heating area at an orientation generally towards the center of the heating area such that this exiting portion of cleaning fluid contacts components of the food serving heating apparatus which extend into the center of the heating area.
